(19) United States
(12) Patent Application Publication
(10) Pub. No.: US 2018/0051694 A1
(43) Pub. Date: Feb. 22, 2018

(54) ELECTRO-MECHANICAL CONTROLLER FOR ADJUSTING PUMP STROKE ON-THE-GO

(71) Applicant: Clemson University, Clemson, SC (US)

(72) Inventors: Ali Mirzakhani-Nafchi, Blackville, SC (US); Ahmad Khalilian, Aiken, SC (US); Young Jo Han, Clemson, SC (US); Nicholas Grant Rogers, Unicoi, TN (US)

(21) Appl. No.: 15/680,687

(22) Filed: Aug. 18, 2017

Related U.S. Application Data
(60) Provisional application No. 62/376,638, filed on Aug. 18, 2016.

(51) Int. Cl. F04C 14/08

(52) U.S. Cl. CPC F04C 14/08; F16H 37/124

(57) ABSTRACT

An electro-mechanical controller is provided for adjusting the pump-stroke in a variety of variable-rate positive displacement piston pumps. The electro-mechanical controller can be attached to work with existing pumps or, in some embodiments, can be integrated into the pump. Using a linear actuator coupled to a pair of nested gears, the actuation of the linear actuator can be transferred into a rotating motion capable of rotating the pump setting adjustment, allowing for “on-the-go” adjustment of the pump-stroke in the variable-rate positive displacement piston pump. The electro-mechanical controllers can be particularly useful in agricultural settings to adjust the amount of fertilizer applied to the soil in response to a variety of inputs such as the GPS or map data, or a signal from a sensor indicating the amount of nitrogen in the soil or plant.

### CROSS-REFERENCE TO RELATED APPLICATIONS

This application claims priority to, and the benefit of, co-pending U.S. provisional application entitled “ELECTRO-MECHANICAL CONTROLLER FOR ADJUSTING PUMP STROKE ON-THE-GO” having Ser. No. 62/376,638, filed Aug. 18, 2016, the contents of which are incorporated by reference in their entirety.

### STATEMENT REGARDING FEDERALLY SPONSORED RESEARCH OR DEVELOPMENT

This invention was made with government support under grant/contract #69-3A75-14-268, awarded by USDA-NRCS. The government has certain rights in the invention.

### TECHNICAL FIELD

The present disclosure generally relates to pumps for chemical metering.

### BACKGROUND

Nutrient application systems are designed to apply a relatively uniform amount of a fertilizer to agricultural fields. Considerable variation occurs within and across production fields in soil texture, soil type, and other major factors which affect crop production and will have a major impact on fertilizer management strategies. Therefore, uniform application of a fertilizer over the entire field can be both costly and environmentally unsound. On average, growers in the US apply about 90 lb/acre nitrogen for cotton, 140 lb/acre for corn, and 90 lb/acre for wheat for a total of 9 million tons just for these three crops. Sensor-based, variable-rate fertilizer application has a potential to reduce fertilizers application rates by half. Even a 20% reduction in nitrogen usage could save cotton, corn and wheat growers over $1.8 billion annually.

Variable-rate positive displacement piston pumps are widely used for metering chemicals with high level of repetitive accuracy and are capable of pumping a wide range of chemicals. These pumps have ability to vary capacity manually or automatically as process conditions require. For axial positive displacement piston pumps, movement of the swash plate controls pump output from zero to maximum. Crankshaft type variable-rate piston pumps (such as John Blue) are used widely in agriculture, due to their rugged design. Currently, there are over one million crankshaft-type positive-displacement piston pumps in the US, which are used by row-crop and hay farmers for applying crop inputs. The outlet flow of these pumps can be changed by adjusting pump stroke manually (stop and go), using specific tools provided by the company. The “on-the-go” outlet flow can only be varied by changing the drive shaft speed. However, for each manual setting, only limited range of flow rate can be achieved by changing the drive shaft speed. This limited flow range is not sufficient for applying variable-rate crop inputs in fields with tremendous amount of variations in soil types, resulting in practice that is wasteful, costly, and environmentally questionable.

There is a need for a controller which can adjust the pump stroke on-the-go, e.g. for real-time, variable-rate application of crop inputs.

### SUMMARY

Various controllers are provided that overcome the aforementioned problems, allowing for adjustment of pump stroke on-the-go”. In some embodiments, the controllers can replace the current manual stroke adjustment system on positive displacement piston pumps. In some embodiments, the controllers can be built into the positive displacement piston pump. This affordable system can include, but is certainly not limited to, a set of male and female spiral or helical gears coupled to a linear actuator for controlling the stroke of the piston pump, a position sensor (such as LVDT, linear potentiometer, a discrete digital or analog position sensor, etc.), solid-state relays, and an embedded controller with software for closed-loop (feedback) control of the linear actuator from the position information. This system can be retrofitted on existing piston pumps for real-time adjustment of the pump stroke. In various aspects, the system can be controlled using a pre-described position sequences (map-based or real-time sensor-based commands). In addition, in some aspects, the system can adjust pump stroke manually (on-the-go), using a pre-calibrated electric dial. In the various embodiments, this system can be used for metering chemicals in variety of industries from agricultural to chemical industries. Various controllers provided herein can be readily coupled with existing piston pumps, such as the John Blue piston pump, and adjust pump stroke for real-time, variable-rate application of crop inputs, such as fertilizer. In various aspects, the controller can communicate with GPS and any GIS software such as “Farm Site Mate” (Farm Works Software LTD) for precise and map-based application of products. Ability to adjust the pump stroke on-the-go can make it possible to change the flow rate of a piston pump automatically from zero to pump's full capacity. In some aspects, this allows for map-based application of variety of crop inputs in agriculture to match crop needs, or automatically controlling chemical rates in industries where variable dosing is controlled by computer, microprocessor, etc.

In various embodiments, electro-mechanical controllers are provided for adjusting pump-stroke in a variable-rate positive displacement piston pumps. The electro-mechanical controllers can include a linear actuator and a pair of nested gears having a first gear coupled to the linear actuator and a second gear coupled to a rotatable pump setting adjustment. In various aspects, actuation of the linear actuator produces a linear displacement in the first gear, thereby causing a rotation of the second gear. The rotation of the second gear can produce a rotation in the pump setting adjustment, thereby adjusting the pump-stroke in the variable-rate positive displacement piston pump.

In one or more embodiments, the electro-mechanical controllers include a linear actuator couple on one end to a pair of nested gears such that actuation of the linear actuator is transferred by the gears to a rotatable pump setting adjustment, thereby adjusting the pump-stroke in the variable-rate positive displacement piston pump. In various aspects, a first gear is coupled to the linear actuator and a second gear is coupled to a rotatable pump setting adjustment. In some aspects, the first gear is a female spiral gear and the second gear is a male spiral gear disposed and movable within the female spiral gear. In some aspects, the second gear is a female spiral gear and the first gear is a male spiral gear disposed and movable within the female spiral gear.

In one or more embodiments, the electro-mechanical controllers include a controller module or other means of controlling the actuation of the linear actuator. In various aspects, the controller module is electronically coupled to the linear actuator and configured to cause an actuation of the linear actuator in response to one or more input signals. The actuation, which results in the adjustment of the pump-stroke in the variable-rate positive displacement piston pump, can be done in response to one or more of a variety of input signals. The input signals can include, for example, a signal from an electrical dial, a signal from a sensor, a signal from a map source, a signal from a global positioning system (GPS), or a combination thereof. The signal can include a variety of digital and/or analog signals, e.g. in some aspects the signal is a digital signal and the controller module comprises a digital-to-analog converter that converts the digital signal into an analog signal that controls the actuation of the linear actuator.

In one or more embodiments, the electro-mechanical controllers include a controller module having a logic unit configured to receive the one or more input signals, wherein the logic unit computes a desired pump rate, wherein the controller module causes the actuation in the linear actuator to adjust the pump-stroke to achieve the desired pump rate from the variable-rate positive displacement piston pump. For example, in some aspects, the one or more input signals includes an optical signal measuring the amount of nitrogen in a soil proximal to the variable-rate positive displacement piston pump, and the controller module causes the actuation of the linear actuator to adjust the pump-stroke to achieve a desired pump rate of a fertilizer onto the soil.

Other systems, methods, features, and advantages of electro-mechanical controllers for adjusting pump-stroke in variable-rate positive displacement piston pumps, will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description of its various embodiments, described below, when taken in conjunction with the accompanying drawings.

FIG. 1 is a schematic of how an exemplary electro-mechanical controller can be used to adjust the pump-stroke in a variable-rate positive displacement piston pump in response to a variety of inputs.

FIG. 2 is a schematic of the components in an exemplary controller module that can be used in some embodiments of an electro-mechanical controller for adjusting pump-stroke in variable-rate positive displacement piston pumps.

FIG. 3A is a perspective view of an exemplary electro-mechanical controller for adjusting pump-stroke in variable-rate positive displacement piston pump attached to an exemplary pump. FIG. 3B is an exploded view of the exemplary electro-mechanical controller depicted in FIG. 3A.

FIGS. 4A-4D demonstrate the effect of actuation of a linear actuator in the exemplary electro-mechanical controller from fully-extended (FIG. 4A) through various intermediate positions (FIGS. 4B-4C) to fully-contracted (FIG. 4D) to adjust the pump-stroke in a variable-rate positive displacement piston pump.

FIG. 5 is a graph of rates of N at different pump settings, adjusted either manually or with an exemplary electro-mechanical controller.

FIG. 6 is a graph of the correlation between target and actual N rates, using the exemplary Electro-Mechanical Controller.

### DETAILED DESCRIPTION

In various aspects, electro-mechanical controllers are provided for adjusting the pump-stroke in variable rate positive displacement piston pumps. Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting. The skilled artisan will recognize many variants and adaptations of the embodiments described herein. These variants and adaptations are intended to be included in the teachings of this disclosure and to be encompassed by the claims herein.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although any methods and materials similar or equivalent to those described herein can also be used in the practice or testing of the present disclosure, the preferred methods and materials are now described. Functions or constructions well-known in the art may not be described in detail for brevity and/or clarity.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

### Electro-Mechanical Controllers for Adjusting Pump-Stroke

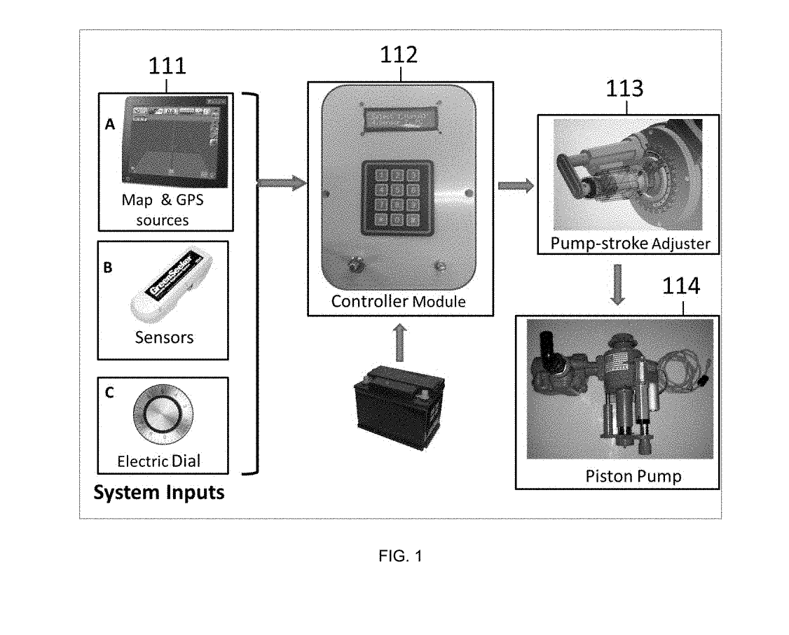

In various embodiments, electro-mechanical controllers are provided for adjusting pump-stroke in a variable-rate positive displacement piston pumps. As depicted in FIG. 1, the electro-mechanical controller can, in some embodiments, include a controller module 112 capable of receiving a variety of systems inputs 111 and producing an adjustment in a pump-stroke adjuster 113 to adjust the pump-stroke in a variable-rate positive displacement piston pump 114 in response to one or more of the inputs 111 e.g. to control a pump-stroke adjuster 113 attached to the variable-rate positive displacement piston pump 114. The inputs can include, for example, the location of the pump on a global positions system (GPS) unit, information from a digital mapping system, various inputs from one or more sensors, and the input from one or more electric dials.

The electro-mechanical controllers can include a linear actuator and a pair of nested gears having a first gear coupled to the linear actuator and a second gear coupled to a rotatable pump setting adjustment. In various aspects, actuation of the linear actuator produces a linear displacement in the first gear, thereby causing a rotation of the second gear. The rotation of the second gear can produce a rotation in the pump setting adjustment, thereby adjusting the pump-stroke in the variable-rate positive displacement piston pump. A variety of linear actuators can be used, for example the linear actuator can be a hydraulic actuator; a pneumatic actuator; an electric actuator, or some combination thereof.

In one or more embodiments, the electro-mechanical controllers include a linear actuator couple on one end to a pair of nested gears such that actuation of the linear actuator is transferred by the gears to a rotatable pump setting adjustment, thereby adjusting the pump-stroke in the variable-rate positive displacement piston pump. In various aspects, a first gear is coupled to the linear actuator and a second gear is coupled to a rotatable pump setting adjustment. In some aspects, the first gear is a female spiral or helical gear and the second gear is a male spiral or helical gear disposed and movable within the female gear. In some aspects, the second gear is a female spiral or helical gear and the first gear is a male spiral or helical gear disposed and movable within the female gear.

In one or more embodiments, the electro-mechanical controllers include a controller module or other means of controlling the actuation of the linear actuator. In various aspects, the controller module is electronically coupled to the linear actuator and configured to cause an actuation of the linear actuator in response to one or more input signals. The actuation, which results in the adjustment of the pump-stroke in the variable-rate positive displacement piston pump, can be done in response to one or more of a variety of input signals. The input signals can include, for example, a signal from an electrical dial, a signal from a sensor, a signal from a map source, a signal from a global positioning system (GPS), or a combination thereof. The signal can include a variety of digital and/or analog signals, e.g. in some aspects the signal is a digital signal and the controller module comprises a digital-to-analog converter that converts the digital signal into an analog signal that controls the actuation of the linear actuator.

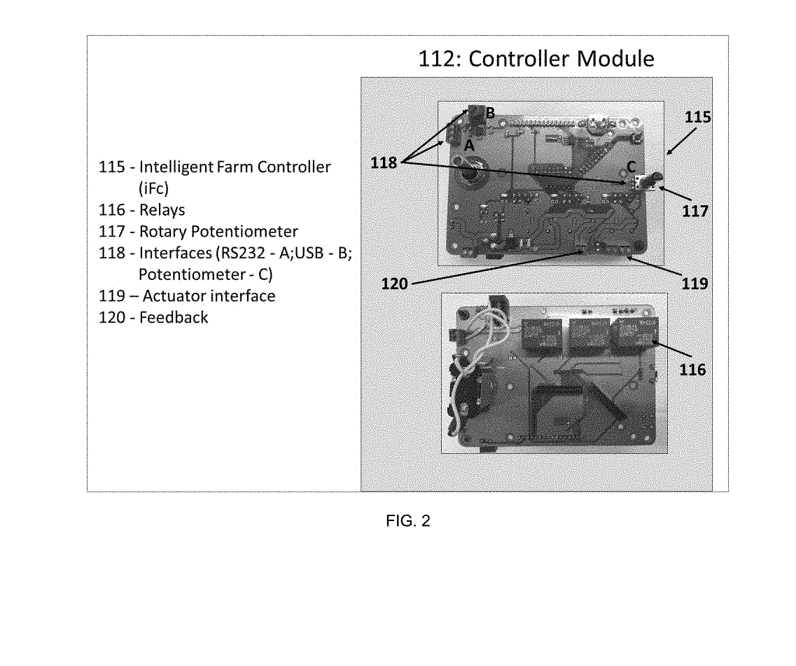

In one or more embodiments, the electro-mechanical controllers include a controller module having a logic unit configured to receive the one or more input signals, wherein the logic unit computes a desired pump rate, wherein the controller module causes the actuation in the linear actuator to adjust the pump-stroke to achieve the desired pump rate from the variable-rate positive displacement piston pump. The input signals can include those from optical sensors, pressure sensors, flow sensors, or any number of other sensors capable of providing information on flow rate, application rate, or the like. For example, in some aspects, the one or more input signals includes an optical signal measuring the amount of nitrogen in the soil or plant proximal to the variable-rate positive displacement piston pump, and the controller module causes the actuation of the linear actuator to adjust the pump-stroke to achieve a desired pump rate of a fertilizer onto the soil. An exemplary controller module can include one or more of the components from FIG. 2, including an I/O control board (such as Intelligent Farm Controller, developed at Clemson) 115 that can receive one or more inputs and may include a logic unit to compute a desired pump stroke in response to the input(s), control relays 116 that can be used, for example, to control a linear actuator (or a motor therein) to cause actuation of the linear actuator, 117 a rotary potentiometer, interfaces (RS232, USB, etc.) for receiving signals from a variety of sensors or rate controllers (such as Raven, AgLeader, Tremble, etc.) 118, actuator interface for controlling the actuation of the linear actuator to adjust the pump-stroke 119, and/or feedback from a variety of sensors (such as flowmeter, position sensor, pressure sensor, etc.) 120.

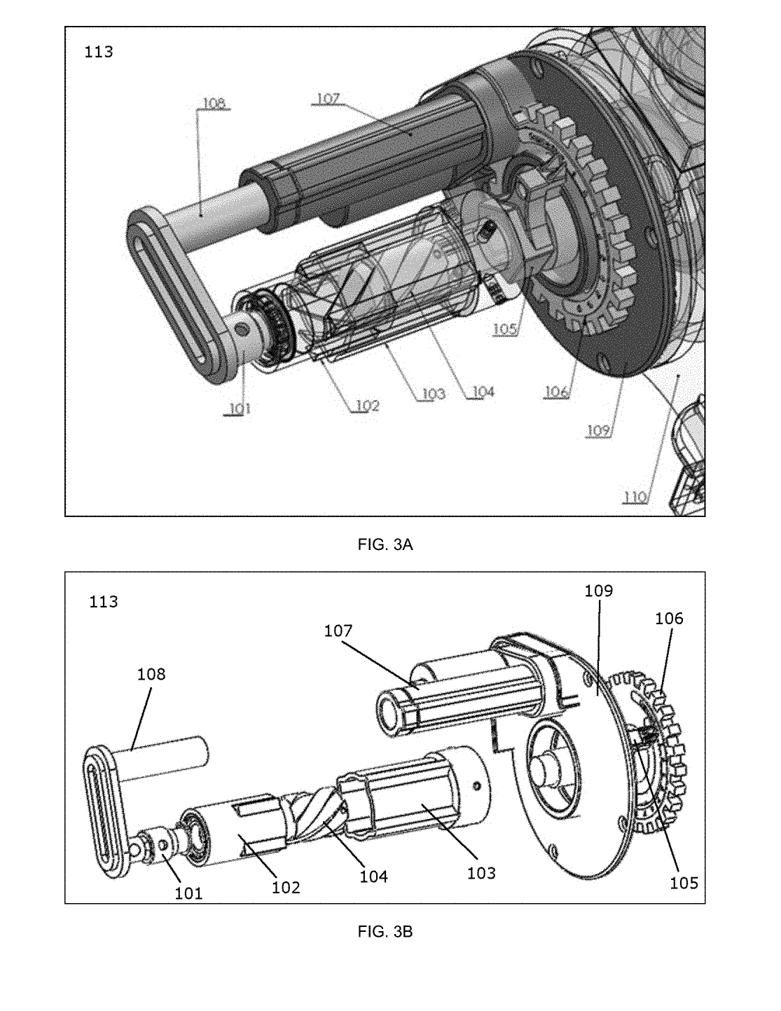

An exemplary pump-stroke adjuster 113 for an electro-mechanical controller is depicted in FIGS. 3A-3B. The pump-stroke adjuster 113 can include a linear actuator 107 having an actuator arm 108 coupled to a female spiral gear 102. The actuator arm 108 can be coupled to the female spiral gear 102 in a rotatable manner, e.g. using a bearing assembly 101 such that the female spiral gear 102 can rotate relative to the actuator arm 108. The pump-stroke adjuster 113 can also include a male spiral gear 104 disposed and movable within the female spiral gear 102 such that a linear displacement in the female spiral gear 102 produces a rotation of the male spiral gear 104. The pair of gears can optionally be enclosed within a cover 103 for protection. The male spiral gear 104 is coupled to a rotatable pump setting adjustment, e.g. to the pump setting pointer 105 so that the rotation of the male spiral gear 104 produces a rotation of the pump setting pointer 105 relative to the pump setting hub 106. The linear actuator 107 can be attached to the base plate 109 on the side of the pump 110.

As depicted in FIGS. 4A-4D, the actuation of the linear actuator 107 can result in motion of the actuator arm 108 from an extended position (FIG. 4A) through intermediate levels of extension (FIGS. 4B-4C) to a completely contracted position (FIG. 4D), causing the pump-setting pointer 106 to rotate from a first (minimum pump-stroke) position 121a through intermediate pump-stroke positions 121b and 121c, to a final (full pump-stroke) position 121d.

The electro-mechanical controllers provided herein can be used to adjust the pump-stroke in a variety of variable-rate positive displacement piston pumps. A variety of methods are provided for adjusting pump-stroke in a variable-rate positive displacement piston pump, the method including adjusting the pump-stroke using an electro-mechanical controller provided herein. Methods of adjusting pump-stroke in a variable-rate positive displacement piston pump are provided, the methods including causing actuation of a linear actuator to produce a displacement of a first gear coupled to the linear actuator. The first gear can, for instance, form a pair of nested gears with a second gear such that the displacement of the first gear causes a rotation in the second gear. The second gear can be coupled to a rotatable pump setting adjustment on a variable-rate positive displacement piston pump such that the rotation of the second gear produces a rotation of the pump setting adjustment, thereby adjusting the pump-stroke in the variable-rate positive displacement piston pump.

By adjusting the pump-stroke, the methods described herein can be used to adjust the capacity on-the-go in a variable-rate positive displacement piston pump, optionally by adjusting both the pump-stroke and the drive shaft speed to achieve a desired capacity for metering of a chemical. For example, the chemical can be a fertilizer where the capacity is adjusted to achieve a desired application rate of the fertilizer on a soil proximal to the piston pump. The desired application rate of fertilizer can be determined in a number of ways, for example, from a map, by an electric knob adjustment remote from the piston pump, or using data from a sensor. In some instances, the capacity is adjusted to achieve a desired application rate of the fertilizer on a soil proximal to the piston pump, wherein the desired application rate is determined, at least in part, based upon a measurement the amount of nitrogen in a soil or plant proximal to the variable-rate positive displacement piston pump.

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

An exemplary electro-mechanical controller for adjusting pump-stroke similar to that depicted in FIGS. 3A-3B was constructed and attached to a Johnson Blue variable-rate positive displacement piston pump. As depicted in FIGS. 4A-4D, by adjusting the setting on the pump setting adjustment from position 0 through position 10 (the increasing position number indicates an increasing pump-stroke), the amount of applied nitrogen can be increased or decreased over a much larger range from about 0 lb. N/ac to about 600 lbs. N/ac.

The electronic controller module included a high performance, low-power 8-bit microcontroller (Atmega644P, Atmel, San Jose, Calif.), which has 64 kilobytes of program memory, 2 kilobytes of EPROM, and 32 programmable I/O lines. All components of the electronic controller module were developed at the Edisto REC Sensor and Automation Laboratory. Aside from controlling the linear actuator, the module has external interfaces to both an NDVI sensor (Trimble GreenSeeker, Sunnyvale, Calif.), through a RS232 and to a Personal Computer (PC) through a Universal Serial Bus (USB). The controller was also equipped with a one-turn potentiometer input (Poti), which provided a manual control for the actuator. The NDVI sensor interface allows automatic adjustment of the linear actuator based on the NDVI sensor values, while the PC interface allows map-based control, using PC-based software.

### Field Tests

System performance tests were conducted under actual field conditions. The first test was conducted to determine the accuracy of the electric dial for changing the pump's stroke length compared to manually adjusted pump stroke (using special tools provided by the manufacturer). Tests were replicated four times for each pump settings. A simple device was developed to collect N samples during the field test. A 3-way solenoid valve was inserted at the discharge end of each chemical hose. In normal solenoid mode the system applied N to the row crop. By energizing the solenoid, N was directed into a collection bottle installed at each row of the applicator. Samples were collected for 100 ft. and the measured rates of N from manually and electronically controlled systems were compared. In addition, the Clemson Electro-mechanical Controller was used to apply different rates of N under field condition. Six target rates (10, 40, 60, 80, 100, and 145 lbs./acre) were selected for the controller's performance test. Again, N samples were collected for 100 ft. using the 3-way solenoid valve system. The target and actual measured N rates were compared to determine the accuracy of the system.

### Results

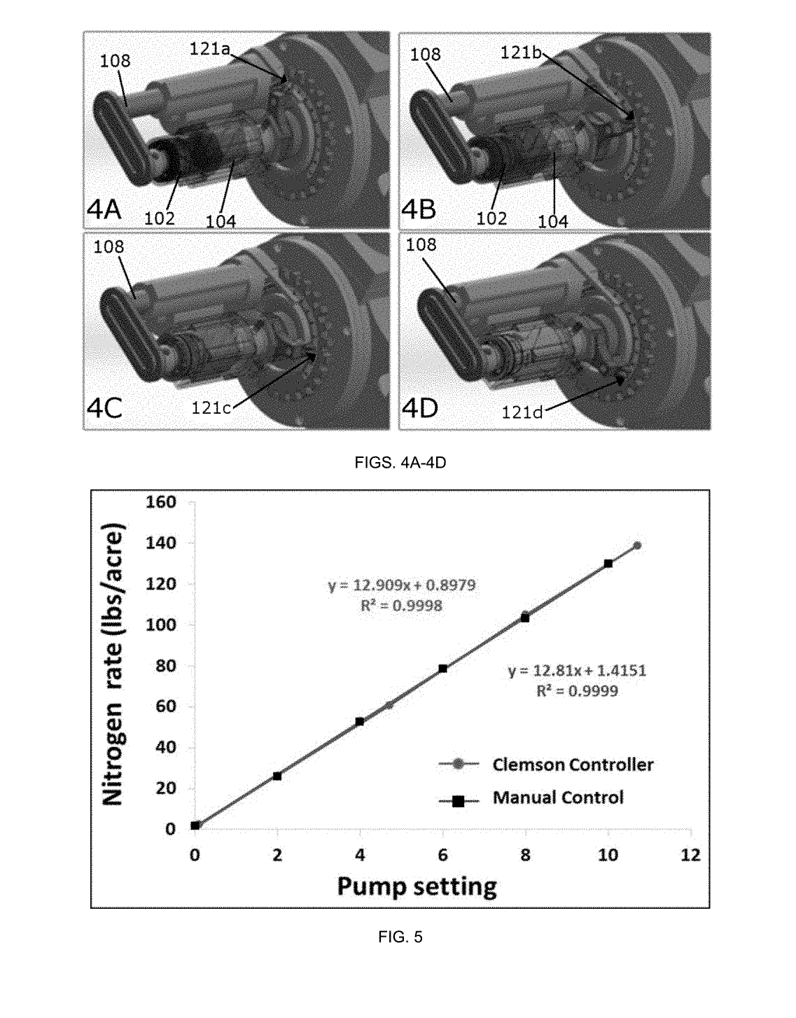

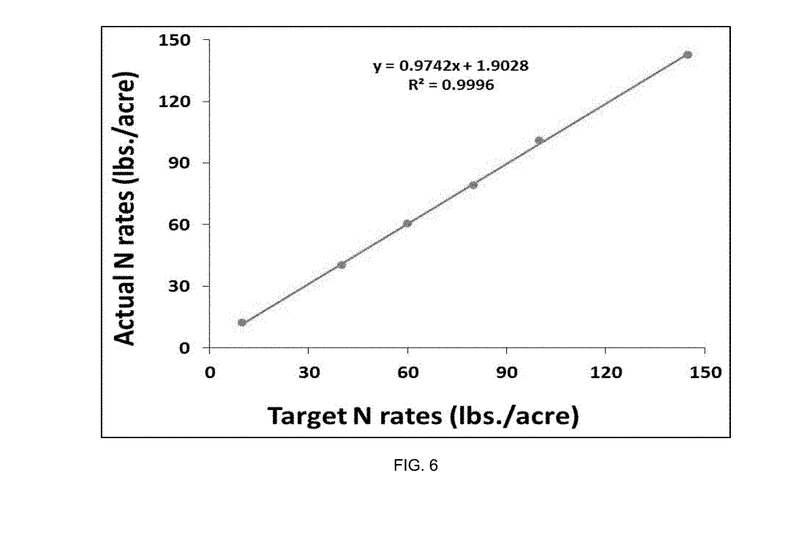

The system closely followed the design specifications. The results of field test showed an excellent correlation (R²=0.9999) between pump outlet flows collected either by manually adjusting the pump stroke or using the Clemson Controller (FIG. 5). The Clemson Controller closely followed the assigned target N rates. The result of variable-rate N application accuracy tests is given in FIG. 6. There was a very good correlation between targeted and measured N rates with an average overall error of less than 1% and maximum absolute error of 1.2%. This indicates that it is possible to match N rates with the spatial field variability to reduce fertilizer inputs and expenditures.

The controller also successfully converted the GreenSeeker NDVI data into N rates, using a flowchart, and controlled actuator's travel distance with similar accuracy of electric dial tests. It was also easy to enter “User Inputs” into the controller, using the keyboard on the controller box. The system also displayed the NDVI values and N rates on the controller's display.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

We claim:

1. An electro-mechanical controller for adjusting pump-stroke in a variable-rate positive displacement piston pump, the electro-mechanical controller comprising
a linear actuator, and
a pair of nested gears comprising a first gear coupled to the linear actuator and a second gear coupled to a rotatable pump setting adjustment,
wherein actuation of the linear actuator produces a linear displacement in the first gear causing a rotation of the second gear,
wherein the rotation of the second gear produces a rotation of the pump setting adjustment, thereby adjusting the pump-stroke in the variable-rate positive displacement piston pump.

2. The electro-mechanical controller of claim 1, wherein the first gear is a female spiral or helical gear and the second gear is a male spiral or helical gear disposed and movable within the female gear.

3. The electro-mechanical controller of claim 1, wherein the second gear is a female spiral or helical gear and the first gear is a male spiral or helical gear disposed and movable within the female gear.

4. The electro-mechanical controller of any one of claims 1-3, further comprising a controller module electronically coupled to the linear actuator and configured to cause an actuation of the linear actuator in response to one or more input signals.

5. The electro-mechanical controller of claim 4, wherein one or more of the input signals are selected from the group consisting of a signal from an electrical dial, a signal from a sensor, a signal from a map source, a signal from a global positioning system (GPS), and a combination thereof.

6. The electro-mechanical controller of claim 4 or claim 5, wherein the input signal is a digital signal and the controller module comprises a digital-to-analog converter that converts the digital signal into an analog signal that controls the actuation of the linear actuator.

7. The electro-mechanical controller of any one of claims 4-6, wherein the controller module comprises a logic unit configured to receive the one or more input signals,
wherein the logic unit computes a desired pump rate,
wherein the controller module causes the actuation in the linear actuator to adjust the pump-stroke to achieve the desired pump rate from the variable-rate positive displacement piston pump.

8. The electro-mechanical controller of any one of claims 4-7, wherein the one or more input signals includes an optical signal measuring the amount of nitrogen in a soil or plant proximal to the variable-rate positive displacement piston pump, and
wherein the controller module causes the actuation of the linear actuator to adjust the pump-stroke to achieve a desired pump rate of a fertilizer onto the soil.

9. A variable-rate positive displacement piston pump comprising an electro-mechanical controller according to any one of claims 1-8 for adjusting pump-stroke of the variable-rate positive displacement piston pump.

10. A method of adjusting pump-stroke in a variable-rate positive displacement piston pump, the method comprising adjusting the pump-stroke using an electro-mechanical controller according to any one of claims 1-9.

11. A method of adjusting pump-stroke in a variable-rate positive displacement piston pump, the method comprising causing actuation of a linear actuator to produce a displacement of a first gear coupled to the linear actuator,
wherein the first gear forms a pair of nested gears with a second gear and the displacement of the first gear causes a rotation in the second gear,
wherein the second gear is coupled to a rotatable pump setting adjustment on a variable-rate positive displacement piston pump and the rotation of the second gear produces a rotation of the pump setting adjustment, thereby adjusting the pump-stroke in the variable-rate positive displacement piston pump.

12. A method of adjusting the capacity of a variable-rate positive displacement piston pump, the method comprising adjusting both the pump-stroke and the drive shaft speed to achieve a desired capacity for metering of a chemical,
wherein the pump-stroke is adjusted according to the method of claim 10 or claim 11.

13. The method of claim 12, wherein the chemical is a fertilizer and the capacity is adjusted to achieve a desired application rate of the fertilizer on a soil proximal to the piston pump.

14. The method of claim 12, wherein the desired application rate is determined, at least in part, based upon a measurement the amount of nitrogen in a soil or plant proximal to the variable-rate positive displacement piston pump.
